(19) United States
(12) Patent Application Publication
(10) Pub. No.: US 2026/0142109 A1
(43) Pub. Date: May 21, 2026

(54) HIGH-VOLTAGE CONTACTOR WITH ULTRASONIC WAVE INSERTION SURFACE

(71) Applicant: PIERBURG GMBH, NEUSS (DE)

(72) Inventors: PETER KUESGEN, NEUSS (DE); JURI WAGNER, NEUSS (DE); DANIEL FUHRMANN, NEUSS (DE)

(73) Assignee: PIERBURG GMBH, NEUSS (DE)

(21) Appl. No.: 18/951,684

(22) Filed: Nov. 19, 2024

(51) Int. Cl. H01H 50/02; H01H 50/54

(52) U.S. Cl. CPC H01H 50/023; H01H 50/541

(57) ABSTRACT

A high-voltage contactor includes an actuator, a housing having a body and a cover, first and second contact elements fixed to the housing, and an electrically conductive contact bridge. The cover is connected to the body in a gas-tight manner via an ultrasonic welded connection and encloses a contact chamber. The cover has a cover wall having first and second axial wall sides arranged opposite to each other. An axial ultrasonic wave insertion surface is arranged on the first axial side wall. The ultrasonic welded connection is arranged on the second axial wall side axially opposite to the ultrasonic wave insertion surface. The contact bridge is arranged in the contact chamber and is displaceable, via the actuator, into a contact position where the first and second contact elements are electrically connected, and into an open position which interrupts an electrical contact between the first and second contact elements.

### FIELD

The present invention is directed to a high-voltage contactor comprising an electromagnetic actuator with a coil and a ferromagnetic armature which is movable by the coil, a housing with a housing body and a housing cover which together enclose a contact chamber, an electrically conductive contact bridge which is arranged in the contact chamber and which is displaceable via the actuator into a contact position, in which a first contact element, which is fixed to the housing, is electrically connected via the contact bridge to a second contact element, which is fixed to the housing, and which is displaceable into an open position in which an electrical contact between the first contact element and the second contact element is interrupted.

### BACKGROUND

Such high-voltage contactors are required to connect and disconnect electrical connections in an electrically load-free or load state, wherein voltages of over 1000 V and currents of over 1000 A can occur in the load state. Such loads can, for example, occur between the traction battery and the drive motor or between a charging station and the traction battery in a battery-powered electric vehicle.

The housing of such a high-voltage contactor is typically gas-tight so that no gas exchange with the environment is possible. The contact chamber is in particular gas-tight, which is advantageous for the extinguishing of arcs that may occur when the contact bridge is disconnected from the contact elements.

### SUMMARY

An aspect of the present invention is to provide a high-voltage contactor with a gas-tight housing which is relatively cost-efficient to manufacture.

In an embodiment, the present invention provides a high-voltage contactor which includes an electromagnetic actuator comprising a coil and a ferromagnetic armature which is configured to be movable via the coil, a housing comprising a housing body and a housing cover, a first contact element which is fixed to the housing, a second contact element which is fixed to the housing, and an electrically conductive contact bridge. The housing cover is connected to the housing body in a gas-tight manner via an ultrasonic welded connection. The housing body and the housing cover are together arranged to enclose a contact chamber. The housing cover comprises a housing cover wall which comprises a first axial wall side and a second axial wall side. The first axial wall side is arranged opposite to the second axial wall side. An axial ultrasonic wave insertion surface is arranged on the first axial side wall of the housing cover wall. The ultrasonic welded connection comprises a welding joint which is arranged on the second axial wall side of the housing cover wall axially opposite to the ultrasonic wave insertion surface. The electrically conductive contact bridge is arranged in the contact chamber and is configured to be displaceable, via the electromagnetic actuator, into a contact position where the first contact element is electrically connected to the second contact element, and into an open position where an electrical contact between the first contact element and the second contact element is interrupted.

### BRIEF DESCRIPTION OF THE DRAWINGS

The present invention is described in greater detail below on the basis of embodiments and of the drawings in which:

FIG. 1 shows a voltage contactor according to the present invention in a cross-sectional front view in a state prior to an ultrasonic welding; and

FIG. 2 shows a detailed view of the welding joint of the high-voltage contactor of FIG. 1.

### DETAILED DESCRIPTION

Only the term “high-voltage contactor” is used below for reasons of simplicity although the present invention also relates to a high-voltage relay. The terms “radial”, “axial”, and “diametral” further refer to the central axis of the actuator along which the armature of the actuator is linearly movable.

The high-voltage contactor according to the present invention comprises a linear electromagnetic actuator. An electromagnetic actuator is thereby to be understood as any actuator that generates a linear movement due to a force caused by electromagnetism. The electromagnetic actuator comprises a coil which can, for example, comprise a coil carrier and a coil winding which is wound thereon, as well as a ferromagnetic armature which is movable due to the electromagnetic force of the activated actuator and which is arranged, for example, inside the coil.

The high-voltage contactor further comprises a multi-part housing with a housing body and a housing cover which together enclose a contact chamber which is arranged axially adjacent to the actuator. The housing cover bounds the contact chamber at an axial end side, wherein the remaining contact chamber walls bounding the contact chamber are defined by the housing body, wherein the contact chamber walls are connected to each other in a gas-tight, in particular in an air-tight manner. The contact chamber walls on the housing body side can, for example, be integrally connected to each other.

The high-voltage contactor is provided with a first and a second contact element which are both fixed to the housing, which both protrude into the contact chamber, and which can both be permanently connected outside the high-voltage contactor to a respective busbar, wherein in a motor vehicle, one of the busbars can be connected to a traction battery and the other busbar can, for example, be connected to power electronics of an electric vehicle drive motor or to a charging station outside the vehicle. An electrical connection between these two contact elements can be provided via a contact bridge which is moved in the contact chamber along a linear movement axis via the actuator. By energizing a coil winding of the electromagnetic actuator, the contact bridge, which can be provided with two electrical contacts plates at its ends, is usually moved axially against the two contact elements attached to the housing to provide an almost resistance-free electrical connection between the first contact element and the second contact element via the contact bridge when the contact bridge is in a first position, i.e., the contact position.

For opening the electrical connection, the electromagnetic actuator is electrically deactivated so that the contact bridge is brought into an opening position in which the electrical connection between the first contact element and the second contact element is interrupted.

The housing cover is connected to the housing body by an internal welded connection in a gas-tight manner so that the contact chamber is completely sealed against the atmosphere. No gas/air exchange or pressure equalization with the atmosphere is therefore provided. Diffusion processes may, however, result in a negligibly low air exchange. Basically, when an arc is created in the contact chamber, a relatively high gas pressure is suddenly generated compared to the atmosphere which cannot be equalized or reduced immediately due to the lack of gas/air exchange and pressure equalization between the contact chamber and the atmosphere. The high gas pressure is, however, advantageous in extinguishing the arcs.

The gas-tight and, for example, internal welded connection can be produced by using an ultrasonic welding process in which a so-called sonotrode of an ultrasonic welding device is positioned on the outside of the housing which generates friction and heat in the material by generating and inserting ultrasonic waves. Since the insertion of the ultrasonic waves should be provided at a relatively short distance from a welding joint, the sonotrode must be positioned relatively close to the joint. This distance should be less than 6 mm, for example, 5 mm, 4 mm, 3 mm, 2 mm or 1 mm.

The present invention provides that the outside of the housing cover is provided with an axial ultrasonic wave insertion surface on which the sonotrode can be positioned in order to insert the ultrasonic waves. The ultrasonic wave insertion surface is arranged at a first axial wall side of the housing cover wall, wherein a welding joint of the ultrasonic welding connection is arranged at a second axial wall side of the housing cover wall axially opposite to the first axial wall side and opposite to the ultrasonic wave insertion surface. The housing cover wall can, for example, be aligned so that the first and second axial wall sides are axially opposite to each other. The welding joint is accordingly arranged axially opposite to the ultrasonic wave insertion surface. The wall thickness of the housing cover wall in the region of the ultrasonic wave insertion surface is a few millimeters, for example, less than 5 mm, for example, less than 4 mm, for example, less than 3 mm, for example, less than 2 mm. The welding joint refers to the location where the two components to be welded together, namely, the housing cover and the housing body, are in direct axial contact with each other before the welding process and where the welded seam is to be created. This means that the part of the welding joint at the housing cover side is formed by the housing cover wall itself so that the housing body is welded to the housing cover wall directly adjacent to the ultrasonic wave insertion surface. The distance between the welding joint and the ultrasonic wave insertion surface therefore corresponds approximately to the wall thickness of the housing cover wall in between so that the ultrasonic waves are inserted directly next to the welding joint, thereby resulting in a reliable and sealed welded seam.

In an embodiment of the present invention, the ultrasonic wave insertion surface can, for example, be arranged perpendicular to the central axis of the actuator. During assembly, the housing cover can, for example, be seated on the housing body in an axial direction. It is therefore advantageous that the sonotrode is also seated on the ultrasonic wave insertion surface in the axial direction. The housing cover is additionally formed in a step-like manner, wherein the ultrasonic wave insertion surface is offset axially in the direction of the actuator with respect to an outer end surface of the housing cover so that the ultrasonic wave insertion surface is formed in an annular shape. An annular sonotrode can therefore be brought relatively close to the welding joint to provide a relatively homogeneous welded seam and therefore provide that the ultrasonic welded connection is sealed tightly.

The housing body can, for example, comprise an axially acting stop. Using the stop, the housing body can be supported and fixed in a corresponding holding device when the sonotrode is seated axially on the ultrasonic wave insertion surface to create the ultrasonic welded connection. The stop can, for example, be positioned with a relatively small axial distance to the ultrasonic wave insertion surface, whereby the housing can be aligned relatively precisely and can be held securely during the welding process without any additional fastening device in a form-fitted manner.

In a related and further embodiment of the present invention, the stop can, for example, be designed as a radially outwardly projecting protrusion with a stop surface. The protrusion can, for example, extend completely around the housing body in the circumferential direction. Several separate individual protrusions arranged at a distance from each other over the circumference can also be provided. The protrusion is relatively easy to manufacture and can also serve to assist assembly during the assembly of the high-voltage contactor in the end product, for example, in a vehicle.

The stop surface of the protrusion can, for example, be arranged perpendicular to the central axis. The stop surface of the protrusion is in particular arranged parallel to the ultrasonic wave insertion surface. This arrangement allows the housing body to be aligned relatively precisely so that the housing cover is fully seated on the housing body thereby forming a relatively uniform welding joint, which allows a particularly uniform insertion of ultrasonic waves and thus allows the formation of a particularly homogeneous and tightly sealed welded seam.

In an embodiment of the present invention, the housing cover can, for example, comprise a circumferential collar that extends in the axial direction at the radial outside over a contact chamber wall that completely radially surrounds the contact chamber. The collar is accordingly annularly shaped and completely surrounds the housing cover. The collar can, for example, extend in the axial direction over at least 20% of the total height of the high-voltage contactor. The contact chamber wall extends in the axial direction over the entire axial height of the contact chamber and completely surrounds the contact chamber in the circumferential direction. The collar extends over approximately 50% of the height of the contact chamber in the axial direction so that the collar extending over the contact chamber wall additionally reinforces the contact chamber wall, whereby the housing is very well protected against bursting due to the high gas pressures resulting from the arc lighting. The collar can, for example, extend almost to the stop at the housing body side.

In a more detailed embodiment of the present invention, the housing cover wall, which is provided with the ultrasonic wave insertion surface, is provided with a circumferential and radially extending end wall section to which the circumferential collar is connected. The end wall section can, for example, be annularly shaped and can, for example, extend radially inwards from the collar. The collar can, for example, be formed as an integral part of the end wall section, thereby making the housing cover relatively strong and capable of withstanding the high loads caused by the gas pressures in the contact chamber.

The end wall section can, for example, have an axial end surface on an outer side of the housing cover that faces away from the collar, whereby the ultrasonic wave insertion surface is formed by this axial end surface. This allows the sonotrode to have a flat annular contact surface which can be positioned on the ultrasonic wave introduction surface in the axial direction in a process-safe manner so that the ultrasonic waves can be inserted homogeneously over the entire end surface.

The axial end wall section can, for example, have an inner axial end surface that is radially surrounded by the collar. Before the welded connection is welded, the inner axial end surface is in contact with an axial end surface of the contact chamber wall, whereby the welding joint is formed by the inner axial end surface of the end wall section and the axial end surface of the contact chamber wall in contact therewith. After the welded connection has been manufactured, the collar thus encloses the welded connection and the welded seam so that an internal welded connection is produced that has a particularly high sealing effect.

In an embodiment of the present invention, the inner end surface of the end wall section can, for example, comprise an axial joining groove into which the contact chamber wall extends axially. The contact chamber wall extends in the joining groove as a so-called tongue according to the tongue-and-groove principle. The welding joint is thereby defined by the axial end surface of the contact chamber wall and a groove ground of the joining groove, whereby the groove ground axially bounds the joining groove. The welded connection is thus, for example, located in the region of the joining groove.

The housing body wall can, for example, be provided with an energy concentration structure at which the material is first melted during the welding process. The energy concentration structure, which is often also referred to as energy direction generator, is arranged at the axial end of the housing body wall and has a particularly sharp-edged geometry which is designed to concentrate the energy inserted as ultrasonic waves by the sonotrode to melt the welding joint relatively quickly and with a relatively small energy input. The energy direction generator can, for example, be roof-shaped, i.e., has a triangular or V-shaped cross-section and tapers in the direction of the welding joint so that the energy direction generator, for example, contacts the groove ground axially with the pointed, sharp-edged part in the joining groove. The energy direction generator in this case extends completely along the housing body wall and thus along the entire weld joint. The tip angle of the energy direction generator in the contact zone can, for example, be from 60° to 90°, for example, from 70° to 80°, which allows the materials to be welded relatively quickly.

The joining groove can, for example, be adjacent to a radial inner wall of the collar, whereby the collar is arranged adjacent to the contact chamber wall so that a particularly strong housing is created. A gap is formed between the contact chamber wall and the joining groove both at the radial inside and at the radial outside into which the melted material can respectively flow during the welding process. Each radial gap can, for example, have a width of 0.05 mm to 0.5 mm, for example, 0.1 mm to 0.3 mm. The collar also serves as a guide during the assembly process to guide the contact chamber wall into the joining groove when the housing cover is mounted. An inner wall of the collar can be slightly inclined for this purpose so that the opening formed by the collar widens outwards, thereby facilitating the mounting of the housing cover.

In an embodiment of the present invention, the joining groove can, for example, be provided with a U-shaped profile, wherein the groove ground can, for example, be defined as a flat surface. The energy direction generator is in a linear-type contact with the groove ground so that a relatively large amount of friction is generated on a small surface, thereby resulting in a rapid melting of the materials. The profile of the joining groove can alternatively also have other shapes, for example, a semi-circular shape or a trapezoidal shape.

The joining groove can, for example, be arranged axially adjacent to the ultrasonic wave insertion surface. The joining groove is defined within the end wall section, which also comprises the ultrasonic wave insertion surface. This provides that the ultrasonic waves reach the welding joint via the shortest possible path and that the welding joint is heated relatively homogeneously.

In an embodiment of the present invention, the housing body and the housing cover can, for example, each be made of a plastic material. Plastic is relatively light and easy to machine and, due to its low melting point, is particularly suitable for a connection via an ultrasonic welding process.

An embodiment of the present invention is described below with reference to the enclosed drawings.

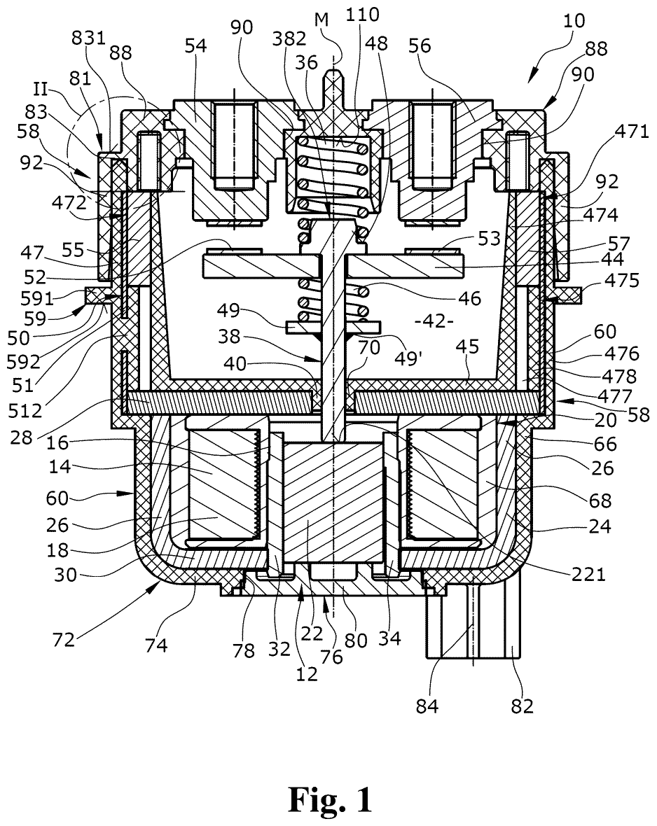

The high-voltage contactor 10 or high-voltage relay shown in FIG. 1 is used, for example, in an electrically driven motor vehicle for the electrical disconnection or connection of a traction battery from or to other electrical components. The high-voltage contactor 10 comprises an electromagnetic actuator 12 which is provided with a coil 14 that comprises a coil carrier 16 and a coil winding 18 wound thereon, a ferromagnetic iron circuit 20, and a ferromagnetic armature 22. The iron circuit 20 comprises a yoke 24 which is bent into a U-shape and whose limbs 26 rest on a back iron plate 28 or are attached to the back iron plate 28 so that the closed iron circuit 20 is defined.

The yoke 24, which defines the electromagnetic flux returning path, is provided at its base section 30 with a central opening 32 whose diameter substantially corresponds to the inside diameter of the coil carrier 16. A sleeve 34 is arranged in the central opening 32, in which sleeve 34 the armature 22 is displaceably arranged and guided. When current flows through the coil 14, the armature 22 is pulled in a well-known manner against the force of a return spring 36 in the contact chamber 42 towards the back iron plate 28 into its closed position. The distal end of the return spring 36 is axially supported and radially guided in a spring support chamber 110 of the housing.

An integral actuating rod 38 contacts the armature 22 axially on its proximal flat end surface 221 on the contact chamber side and extends through a further central opening 40 in the back iron plate 28 into a contact chamber 42.

A contact bridge 44 is arranged at the end 382 of the actuating rod 38 that is opposite the armature 22. The contact bridge 44 is pushed against a stop 48 at the contact bridge-sided end 382 of the actuating rod 38 by a spring element 46 which is designed as a helical spring, the spring element 46 being supported with its other spring end axially on a protrusion 49 of the actuating rod 38. The protrusion 49 is defined by an annular disc that is welded to the actuating rod 38 via a weld 49′. The contact bridge 44 is thereby supported by the actuating rod 38 against the spring force of the spring element 46 in a tiltable and axially movable manner. The stop 48 is also used on its distal side for the centered support of the proximal end of the return spring 36. The spring element 46 can alternatively also be designed as a leaf spring which is supported in the center of the protrusion 49 and whose two leaf spring ends transfer the spring force to the two contact bridge ends.

A contact plate 52, 53 is attached to each end of the contact bridge 44, which is made of a material with a relatively good electrical conductivity. The first contact plate 52 is arranged axially opposite to a first contact element 54, which can in particular be connected to a high-voltage traction battery via a (not shown) busbar. The second contact plate 53 is arranged opposite to a second contact element 56 which can, for example, be connected to an electric drive motor of a motor vehicle via a (not shown) busbar.

The entire high-voltage contactor 10 is arranged in a housing 58 which is made of plastic, the housing 58 being defined by a housing body 60 and a housing cover 88, as shown most clearly in FIG. 1. The actuator 12 is overmolded with plastic to form the housing body 60. This plastic surrounds the coil 14 completely radially to define a radial boundary wall 66 and also fills a space 68 radially between the coil 14 and the yoke 24. The yoke 24 is itself also completely radially enclosed by this plastic and is thereby shielded from the environment. The yoke 24 is itself furthermore completely surrounded radially by this plastic and is thus shielded from the environment. The back iron plate 28, which contacts the coil carrier 16 at that side which faces the coil carrier 16, is also covered axially by this plastic in the direction of the contact chamber 42, whereby an axial contact chamber wall 45 is defined. The further central opening 40 of the back iron plate 28 is also covered radially inwards by the plastic, exposing only a central guide opening 70 in which the actuating rod 38 is guided.

On the axial outer side 72 of the housing body 60, which is opposite the contact chamber 42, the plastic extends further radially inwards along a radially outer region 74 of the base section 30 of the yoke 24 or the actuator 12, only exposing an opening 78 in the central, radially inner section 76, which is defined to be symmetrical to the opening 32 but whose diameter is slightly larger to provide sufficient space for pressing in the sleeve 34.

This opening 78 is closed by a plastic cover 80 which is materially bonded to the housing body 60 in the opening 78, in particular via a laser welding, an ultrasonic welding, or a rotational vibration welding.

The housing body 60, which is manufactured by overmolding the actuator 12, furthermore defines a structure 82 in the form of a plug housing through which the connecting lines 84 to the coil winding 18 of the coil 14 are guided to the outside so that the electrical connection of the coil 14 to a voltage source can be provided via a plug counterpart.

A circumferential radial contact chamber wall 47 also extends from the back iron plate 28 in an extension of the plastic surrounding the actuator 12, which radially bounds the contact chamber 42 and is also integrally manufactured during the overmolding of the actuator 12, and thus defines four side walls of the contact chamber 42 in the present embodiment.

The radial contact chamber wall 47 is provided in a so-called sandwich-type construction. The radial contact chamber wall 47 is formed by a contact chamber inner wall 474 and a contact chamber outer wall 476, which are arranged parallel to and at a distance from each other. A magnetic field conducting body 50, which is formed by a ferromagnetic magnetic field conducting plate 51, is arranged between the contact chamber inner wall 474 and the contact chamber outer wall 476, and radially completely surrounds the contact chamber 42, wherein the radial contact chamber wall 47 or the contact chamber inner wall 474 and the contact chamber outer wall 476 are manufactured by injection molding of plastic around the magnetic field conducting plate 51 on the inside and outside. The injection molding is carried out in the same step in which the actuator 12 is injection molded, whereby the contact chamber outer wall 476 is formed integrally with the housing body 60 and the contact chamber inner wall 474 is formed integrally with the axial contact chamber wall 45. The contact chamber inner wall 474 and the contact chamber outer wall 476 are, however, connected to one another in a materially integral manner at a plurality of locations, for example, via openings 512 in the longitudinal side walls 506 of the magnetic field conducting plate 51.

The contact chamber 42 is cuboid-shaped and therefore has a rectangular cross-section, which is radially bounded by four side walls, each formed by the radial contact chamber wall 47. On the two opposite short sides, the side walls of the radial contact chamber wall 47 each have a cuboid, inward-projecting pocket 471, 472 which are open on that axial side which is opposite with respect to the actuator 12, wherein a permanent magnet 55, 57 is arranged in each pocket 471, 472. Each pocket 471, 472 and each permanent magnet 55, 57 arranged in the pocket 471, 472 is arranged radially adjacent to one of the contact plates 52, 53 of the contact bridge 44. Each permanent magnet 55, 57 is in this case aligned with respect to its magnetic poles so that the Lorentz force exerted by the magnetic fields of the permanent magnets 55, 57 deforms the arc occurring between the contact plates 52, 53 and the contact elements 54, 56 in an arc-shaped manner and, as a result of the resulting elongation and faster cooling, the arcs are thereby extinguished.

The magnetic field conducting plate 51 is not completely overmolded on the inside in the region of the pockets 471, 472. Each permanent magnet 55, 57 instead contacts the magnetic field conducting plate 51 on its respective short inner side, whereby the permanent magnets 55, 57 are magnetically conductively connected to one another. A stop structure 475 is arranged within each pocket 471, 472, the stop structure 475 being formed by two ribs 477 which are arranged parallel and spaced apart from each other, and a wall projection 478. The wall projection 478 extends radially inwards from the inside of the magnetic field conducting plate 51. The ribs 477 each extend radially from the contact chamber inner wall 474 of the contact chamber to the wall projection 478. The permanent magnets 55, 57 are in axial contact with the respective stop structure 475, whereby each permanent magnet 55, 57 is arranged in the contact chamber 42 at the height of the contact locations with respect to the axial direction.

The magnetic field conducting plate 51 also extends axially in the actuator direction up to the back iron plate 28 and is in axial contact with the back iron plate 28 via a flat contact surface 504 so that the magnetic field conducting plate 51 is in a direct magnetically conductive contact with the back iron plate 28 and thus with the iron circuit 20. This results in both an increased local field strength and in an improved homogeneity of the magnetic field, whereby a relatively strong deformation of the arcs, and thus a relatively fast extinguishing of the arcs, is achieved.

The magnetic field conducting plate 51 is formed as a rectangular tube and is made from a flat metal strip by bending. The magnetic field conducting plate 51 is provided with four bending points 507 which form the corners of the magnetic field conducting plate 51.

The contact chamber 42 in FIG. 1 is closed axially on the axial side opposite to the axial contact chamber wall 45 by the housing cover 88, which also axially closes the pockets 471, 472. Two axial openings 90 are defined at the housing cover 88 in which the two contact elements 54, 56 are supported and fixed, for example, by injection molding.

The housing cover 88 is connected to the housing body 60 in a gas-tight manner via an ultrasonic welded connection. The housing cover 88 comprises an ultrasonic wave insertion surface 81 on a housing cover wall 89 which is arranged on a first axial wall side 891 of the housing cover wall 89, wherein a welding joint 85 of the ultrasonic welded connection is arranged on a second axial wall side 892 of the housing cover wall 89, which is opposite to the first axial wall side 891, and opposite to the ultrasonic wave insertion surface 81.

The housing cover wall 89 is formed by a circumferential and radially extending end wall section 83 which is annular and from which a circumferential collar 92 extends axially in the direction of the actuator 12. The collar 92 thereby encloses the radial contact chamber wall 47 radially and extends over about 50% of the contact chamber height. The end wall section 83 comprises an axial end surface 831 at an outer side of the housing cover 88 which faces away from the collar 92, wherein the ultrasonic wave insertion surface 81 is formed by the axial end surface 831.

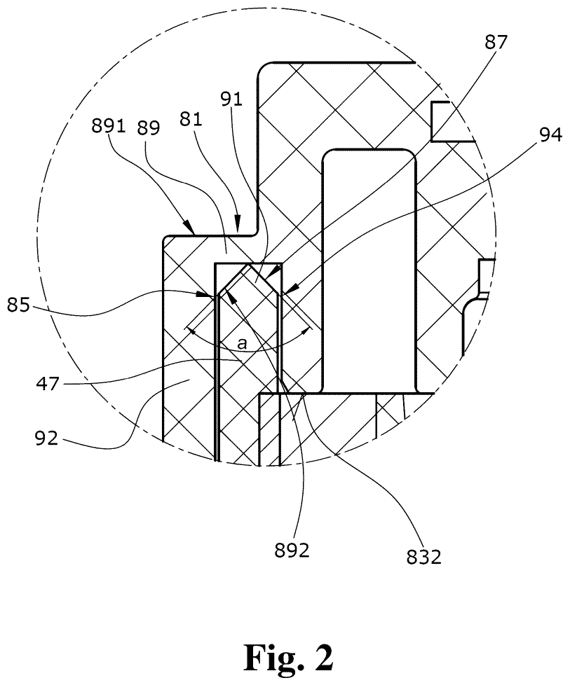

The axial end surface 831 is arranged perpendicular to the center axis M of the actuator 12 and is therefore perpendicular to the axial mounting direction of the housing cover 88. The end wall section 83 also comprises an inner axial end surface 832 which is surrounded by the collar 92, as also shown in FIG. 2. The inner axial end surface 832 comprises an axial joining groove 94 into which the radial contact chamber wall 47, in particular the contact chamber outer wall 476, extends axially with its distal end. The radial contact chamber wall 47 comprises an energy concentration structure 87 which has a triangular or V-shaped profile. The energy concentration structure 87 thereby tapers to a sharp edge in the direction of a groove ground 91 of the joining groove 94 so that the energy concentration structure 87 contacts the groove ground 91 of the joining groove 94 axially under a line-like contact. The corner angle a of the energy concentration structure 87 is thereby approximately 90°.

The joining groove 94 extends circumferentially along the inner radial side of the collar 92 and is adjacent thereto. The joining groove 94 also comprises a U-shaped profile, as can be seen in FIG. 2. The flat groove ground 91 and the energy concentration structure 87 define the welding joint 85 at which the housing cover 88 is welded to the housing body 60. In the axial direction, the joining groove 94 is arranged axially adjacent to the ultrasonic wave insertion surface 81 so that the ultrasonic waves of the sonotrode which is placed axially on the ultrasonic wave insertion surface 81 for producing the ultrasonic welded connection at the axially opposite wall side of the welding joint 85 can be inserted axially and spread axially through the end wall section 83 up to the welding joint 85. A particularly homogeneous and tight-welded connection is thereby produced in the joining groove 94.

The housing body 60 also comprises an axially acting stop 59 which is formed as a radially extending protrusion 591. An axial stop surface 592 is formed at the protrusion 591 which is arranged perpendicular to the center axis M, and via which the housing body 60 is supported axially in a corresponding supporting device during the ultrasonic welding process. The axially acting stop 59 serves as a counter support when the sonotrode is positioned axially on the ultrasonic wave insertion surface 81 to execute the welding process.

If the current flow between the traction electric motor or the charging station and the traction battery is to be allowed, the coil 14 is energized, causing the armature 22 to be pulled towards the back iron plate 28 due to the acting electromagnetic forces. This pushes the actuating rod 38 with the contact bridge 44 and the contact plates 52, 53 against the contact elements 54, 56 so that an electric current can flow from the first contact element 54 to the second contact element 56 via the contact bridge 44 and thus from the battery to the electric motor or from the charging station to the battery. If the coil 14 is not energized, the actuating rod 38 and the armature 22 are moved by the spring force of the return spring 36 in the opposite direction to the previously acting closing force so that the contact bridge 44 is lifted off the contact elements 54, 56 and the electric circuit is interrupted. At high currents, this results in an electric arc, which also causes an increase in pressure in the contact chamber 42.

This pressure increase can be absorbed well by the housing 58 due to the metal-reinforced axial contact chamber wall 45 and the metal-reinforced radial contact chamber wall 47 surrounding the contact chamber 42, and the actuator 12 is also reliably protected, in particular by the molded axial contact chamber wall 45. A complete seal to the outside is achieved due to the sealed welding of the three housing parts so that no gas can escape from the contact chamber 42, the arc is reliably and quickly extinguished, and no gases or liquids can enter from the outside. The required installation space and assembly costs are also very low.

The present invention is not limited to embodiments described herein; reference should be had to the appended claims.

LIST OF REFERENCE NUMERALS

| | |
|---|---|
| 10 | High-voltage contactor |
| 12 | Actuator |
| 14 | Coil |
| 16 | Coil carrier |
| 18 | Coil winding |
| 20 | Iron circuit |
| 22 | Armature |
| 24 | Yoke |
| 26 | Limb |
| 28 | Back iron plate |
| 30 | Base section |
| 32 | Central opening |
| 34 | Sleeve |
| 36 | Return spring |
| 38 | Actuating rod |
| 40 | Further central opening |
| 42 | Contact chamber |
| 44 | Contact bridge |
| 45 | Axial contact chamber wall |
| 46 | Spring element |
| 47 | Radial contact chamber wall |
| 48 | Stop |
| 49 | Protrusion |
| 49′ | Weld |
| 50 | Magnetic field conducting body |
| 51 | Magnetic field conducting plate |
| 52 | First contact plate |
| 53 | Second contact plate |
| 54 | First contact element |
| 55 | Permanent magnet |
| 56 | Second contact element |
| 57 | Permanent magnet |
| 58 | Housing |
| 59 | Axially acting stop |
| 60 | Housing body |
| 66 | Boundary wall |
| 68 | Space |
| 70 | Central guide opening |
| 72 | Axial outer side (of housing body 60) |
| 74 | Radially outer region (of base section 30) |
| 76 | Central, radially inner section |
| 78 | Opening |
| 80 | Plastic cover |
| 81 | Ultrasonic wave insertion surface |
| 82 | Structure |
| 83 | End wall section |
| 84 | Connecting line |
| 85 | Welding joint |
| 87 | Energy concentration structure |
| 88 | Housing cover |
| 89 | Housing cover wall |
| 90 | Axial opening |
| 91 | Groove ground |
| 92 | Collar |
| 94 | Joining groove |
| 110 | Spring support chamber |
| 221 | End surface |
| 382 | End |
| 471 | Pocket |
| 472 | Pocket |
| 474 | Contact chamber inner wall |
| 475 | Stop structure |
| 476 | Contact chamber outer wall |
| 477 | Rib |
| 478 | Wall projection |
| 512 | Opening |
| 591 | Protrusion |
| 592 | Stop surface |
| 831 | Axial end surface |
| 832 | Inner axial end surface |
| 891 | First axial wall side |
| 892 | Second axial wall side |
| a | Corner angle |
| M | Center axis (of actuator 12) |

What is claimed is:

1. A high-voltage contactor comprising:
an electromagnetic actuator comprising a coil and a ferromagnetic armature which is configured to be movable via the coil;
a housing comprising a housing body and a housing cover, the housing cover being connected to the housing body in a gas-tight manner via an ultrasonic welded connection, the housing body and the housing cover together being arranged to enclose a contact chamber, wherein,
the housing cover comprises a housing cover wall which comprises a first axial wall side and a second axial wall side, the first axial wall side being arranged opposite to the second axial wall side,
an axial ultrasonic wave insertion surface is arranged on the first axial side wall of the housing cover wall, and
the ultrasonic welded connection comprises a welding joint which is arranged on the second axial wall side of the housing cover wall axially opposite to the ultrasonic wave insertion surface;
a first contact element which is fixed to the housing;
a second contact element which is fixed to the housing; and
an electrically conductive contact bridge which is arranged in the contact chamber and which is configured to be displaceable, via the electromagnetic actuator, into a contact position where the first contact element is electrically connected to the second contact element via the electrically conductive contact bridge, and into an open position where an electrical contact between the first contact element and the second contact element is interrupted.

2. The high-voltage contactor as recited in claim 1, wherein,
the electromagnetic actuator has a center axis, and
the ultrasonic wave insertion surface is further arranged to be perpendicular to the center axis of the electromagnetic actuator.

3. The high-voltage contactor as recited in claim 2, wherein the housing body comprises an axially acting stop.

4. The high-voltage contactor as recited in claim 3, wherein the axially acting stop comprises a radially outwardly extending protrusion which comprises a stop surface.

5. The high-voltage contactor as recited in claim 4, wherein the stop surface is arranged to be perpendicular to the center axis.

6. The high-voltage contactor as recited in claim 1, further comprising:
a contact chamber wall which is arranged to completely radially enclose the contact chamber,
wherein,
the housing cover further comprises a circumferential collar which extends in an axial direction radially outwardly over the contact chamber wall.

7. The high-voltage contactor as recited in claim 6, wherein,
the housing cover wall further comprises an end wall section which is configured to extend circumferentially and radially, and
the circumferential collar is connected to the end wall section.

8. The high-voltage contactor as recited in claim 7, wherein,
the end wall section comprises an axial end surface on an outer side of the housing cover that faces away from the circumferential collar, and
the ultrasonic wave insertion surface is formed by the axial end surface.

9. The high-voltage contactor as recited in claim 8, wherein,
the contact chamber wall comprises an axial end surface,
the end wall section further comprises an inner axial end surface which is radially surrounded by the circumferential collar, and
the welding joint is formed by the inner axial end surface and by the axial end surface of the contact chamber wall.

10. The high-voltage contactor as recited in claim 9, wherein,
the inner axial end surface of the end wall section comprises an axial joining groove, and
the contact chamber wall is further arranged to extend axially into the axial joining groove.

11. The high-voltage contactor as recited in claim 10, wherein,
the circumferential collar comprises a radial inner wall, and
the axial joining groove is arranged to border on the radial inner wall of the circumferential collar.

12. The high-voltage contactor as recited in claim 10, wherein the axial joining groove has a U-shaped profile.

13. The high-voltage contactor as recited in claim 10, wherein the axial joining groove is arranged axially adjacent to the ultrasonic wave insertion surface.

14. The high-voltage contactor as recited in claim 9, wherein the contact chamber wall further comprises an energy concentration structure.

15. The high-voltage contactor as recited in claim 14, wherein the energy concentration structure has a V-shaped profile.

16. The high-voltage contactor as recited in claim 1, wherein the housing body and the housing cover are each made of a plastic material.
